(19) United States
(12) Patent Application Publication
(10) Pub. No.: US 2024/0278631 A1
(43) Pub. Date: Aug. 22, 2024

(54) COMPACT E-BEAM AXLE GEARBOX

(71) Applicant: Schaeffler Technologies AG & Co. KG, Herzogenaurach (DE)

(72) Inventor: Benedikt Neubauer, Herzogenaurach (DE)

(73) Assignee: Schaeffler Technologies AG & Co. KG, Herzogenaurach (DE)

(21) Appl. No.: 18/110,529

(22) Filed: Feb. 16, 2023

(51) Int. Cl. B60K 1/00; B60K 17/16; F16H 37/08

(52) U.S. Cl. CPC B60K 1/00; B60K 17/16; F16H 37/082; B60K 2001/001

(57) ABSTRACT

An electric beam axle includes an electric motor positioned at a first axial end region and a compound planetary gearset positioned at a second axial end region of the electric beam axle. An input shaft extends between and couples the compound planetary gearset to the electric motor. A spur gear differential is positioned at the second axial end region, and a load stage carrier of the compound planetary gearset extends between and couples the spur gear differential to the compound planetary gearset. The spur gear differential includes a first output shaft and a second output shaft. The first output shaft is connected to a first wheel hub positioned at a first distal end of the electric beam axle. The second output shaft is connected to a second wheel hub positioned at a second distal end of the electric beam axle.

### FIELD OF INVENTION

The present disclosure concerns a beam axle for a vehicle. It is particularly concerned with a compact electric beam axle for an electric or hybrid vehicle.

### BACKGROUND

Electric beam axles are used in hybrid and electric vehicles to transfer rotational energy from the electric motor to the wheels of the vehicle, causing the vehicle to propel in a specified direction. Electric beam axles include the electric motor and the gearing/gearbox required to transfer the rotational energy from the electric motor to the wheels of the vehicle. Based on design requirements, there is a limited space envelope in which the electric motor and the gearing/gearbox must be positioned within the electric beam axle. Therefore, there is a need for an electric beam axle that can efficiently fit the electric motor and the gearing/gearbox for a hybrid and/or electric vehicle within a limited space envelope while maintaining full functionality.

### SUMMARY

In one aspect, the present disclosure is directed to an electric beam axle for a hybrid or electric vehicle. The electric beam axle includes an electric motor positioned at a first axial end region of the electric beam axle. A compound planetary gearset positioned at a second axial end region of the electric beam axle. An input shaft that extends between and couples the compound planetary gearset to the electric motor. The compound planetary gearset comprising a load stage carrier. A spur gear differential positioned at the second axial end region, the load stage carrier extends between and couples the spur gear differential to the compound planetary gearset. The spur gear differential includes a first output shaft and a second output shaft that extend in opposite axial directions. The first output shaft of the spur gear differential is connected to a first wheel hub positioned at a first distal end of the electric beam axle. The second output shaft of the spur gear differential is connected to a second wheel hub positioned at a second distal end of the electric beam axle.

In one embodiment, the input shaft is a hollow shaft, and the first output shaft is positioned at least partially within and concentric to the input shaft.

In one embodiment, the first output shaft extends from the spur gear differential at the second axial end region to the first axial end region of the electric beam axle, coupling the spur gear differential to the first wheel hub.

In one embodiment, the compound planetary gearset is positioned axially between the electric motor and the spur gear differential.

In one embodiment, the electric motor, the compound planetary gearset, and the spur gear differential are each concentric with and surround an axis of rotation of the first and second output shafts of the electric beam axle.

In one embodiment, the compound planetary gearset includes: a first sun gear coupled to the input shaft for receiving rotational energy from the electric motor; a plurality of first planet gears positioned radially outwards from the first sun gear with respect to the axis of rotation of the electric beam axle on a first planet carrier, each of the plurality of first planet gears are configured to mesh with the first sun gear; and a stationary first ring gear positioned radially outwards of the plurality of first planet gears, wherein each of the plurality of first planet gears are configured to mesh with the stationary first ring gear.

In such an embodiment, the compound planetary gearset can further include: a first planet carrier shaft extending from the first planet carrier towards the second distal end; a second sun gear, the first planet carrier shaft rotationally couples the plurality of first planet gears to the second sun gear; and a plurality of second planet gears positioned radially outwards from the second sun gear with respect to the axis of rotation of the electric beam axle on a second planet carrier, each of the plurality of second planet gears are configured to mesh with the second sun gear.

In a further embodiment, the second sun gear is positioned axially closer to the second distal end than the first sun gear.

In a further embodiment, a stationary second ring gear is positioned radially outwards of the plurality of second planet gears, and each of the plurality of second planet gears are configured to mesh with the stationary second ring gear.

In a further embodiment, the second planet carrier rotationally couples the plurality of second planet gears to an input of the spur gear differential.

In a further embodiment, the first sun gear, the plurality of first planet gears, and the first ring gear are positioned axially between the electric motor and the second sun gear, the plurality of second planet gears, and the second ring gear.

In one embodiment, each of the input shaft, the first output shaft, and the second output shaft are axially aligned with the axis of rotation of the of the electric beam axle.

In one embodiment, each of the electric motor, the compound planetary gearset, and the spur gear differential are positioned within a space envelope defined between the first distal end and the second distal end of the electric beam axle.

In a further embodiment, the space envelope includes a dog bone shape, such that the first and second axial end regions of the electric beam axle include an outer diameter larger than an outer diameter of the electric beam axle at a location positioned an equal distance from the first axial end region and the second axial end region.

In one embodiment, the electric beam axle is configured to be a front axle of the hybrid or electric vehicle.

In one embodiment, the compound planetary gearset and the spur gear differential are positioned solely within the second axial end region of the electric beam axle.

In a further embodiment, the compound planetary gearset and the spur gear differential are positioned within an axial length extending from the second distal end towards the first distal end of the electric beam axle, the axial length being between 140 millimeters and 180 millimeters.

In one embodiment, the compound planetary gearset and the spur gear differential have a combined gear ratio of i=18.

In one embodiment, the input shaft, the first output shaft, and components of the electric motor are the only rotating components within the first axial end region of the electric beam axle.

### BRIEF DESCRIPTION OF THE DRAWING(S)

The foregoing Summary as well as the following Detailed Description will be best understood when read in conjunction with the appended drawings, which illustrate a preferred embodiment according to the disclosure. In the drawings:

FIG. 1 is a schematic illustration of an exemplary electric beam axle for a hybrid and/or electric vehicle.

FIG. 2 is a magnified detail view of a portion of the exemplary electric beam axle of FIG. 1.

### DETAILED DESCRIPTION OF THE PREFERRED EMBODIMENT(S)

Certain terminology is used in the following description for convenience only and is not limiting. The words “front”, “rear”, “upper”, and “lower” designate directions in the drawings to which reference is made. The words “inwardly” and “outwardly” refer to directions towards and away from parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terms “generally” and “approximately” are to be construed as within 10% of a stated value or ratio. The terminology includes the words specifically noted above, derivatives thereof, and words of similar import.

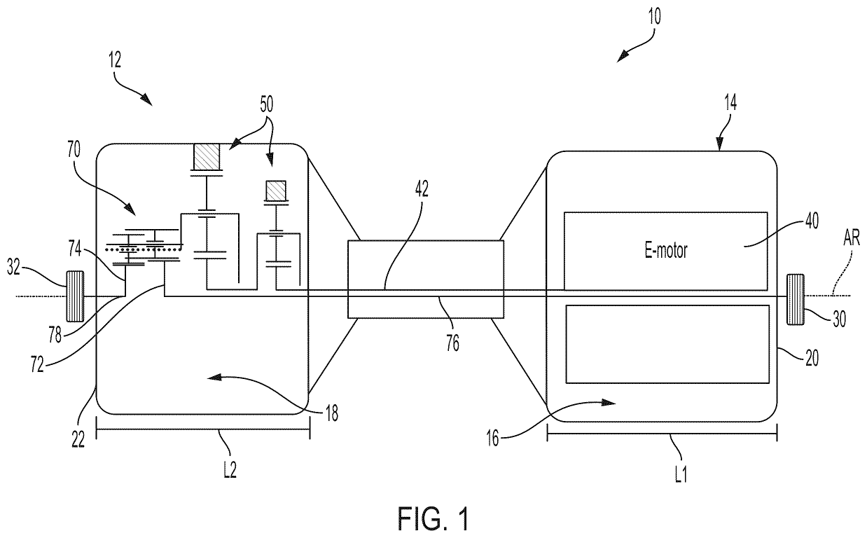

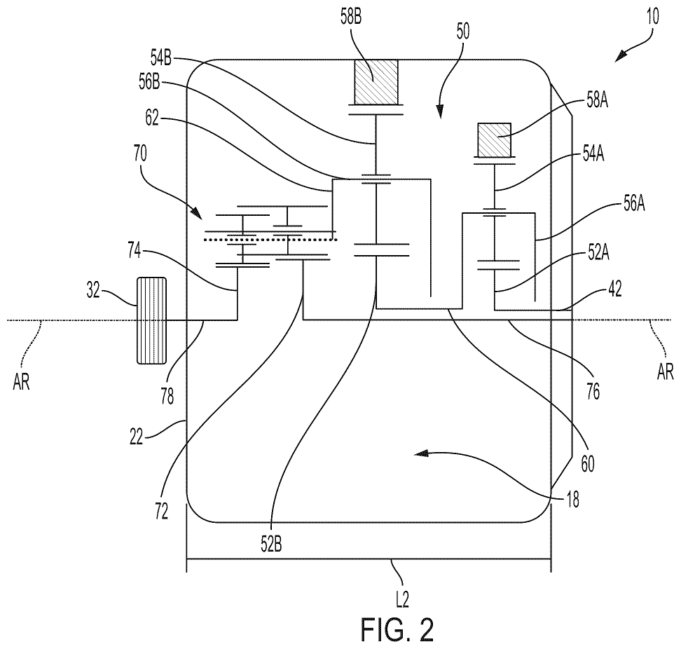

FIG. 1 is a schematic illustration of an exemplary electric beam axle 10 for use in a hybrid and/or electric vehicle. FIG. 2 is a magnified detail view of a portion of the exemplary electric beam axle 10. Specifically, FIG. 2 is a magnified detail view of the second axial end region of the electric beam axle 10. FIGS. 1-2 will be discussed together. FIGS. 1 and 2 schematically illustrate only one half of a gearbox 12 of the electric beam axle 10. But it is to be understood that at least some of the components and features of the gearbox 12 are axially aligned with and surround an axis of rotation AR of the electric beam axle 10, discussed further below. In some examples, the axis of rotation AR can be an axis of rotation of wheels/tires coupled to the electric beam axle 10. Further, the electric beam axle 10 will hereinafter be referred to as the “axle 10”, but it is to be understood that the “electric beam axle 10” and the “axle 10” are used synonymously to refer to the same component/assembly.

The axle 10 is a beam axle for a hybrid and/or electric vehicle (i.e. a hybrid and/or electric automobile), and the axle 10 is configured to transfer rotational energy from an electric motor to the wheels/tires of the vehicle. In some embodiments, the axle 10 can be a front axle of the hybrid and/or electric vehicle. In other examples, the axle 10 can be a rear axle of the hybrid and/or electric vehicle. Due to space constraints within hybrid and/or electric vehicles, the axle 10 is configured to be entirely positioned within a space envelope 14 including a first axial end region 16 having a first distal end 20, and a second axial end region 18 having a second distal end 22. The first axial end region 16 of the space envelope 14 is positioned adjacent a first wheel hub 30 at a first end of the axle 10. The second axial end region 18 of the space envelope 14 is positioned adjacent a second wheel hub 32 at a second end of the axle 10, opposite the first end of the axle 10. Further, the first distal end 20 of the space envelope 14 is the outermost end of the space envelope 14 adjacent the first wheel hub 30. The second distal end 22 of the space envelope 14 is the outermost end of the space envelope 14 adjacent the second wheel hub 32, opposite the first distal end 20 of the space envelope 14.

As schematically illustrated in FIG. 1, the space envelope 14 includes a generally “dog-bone” shape in which the first axial end region 16 and the second axial end region 18 include an outer diameter larger than an outer diameter of the axle 10 at a location positioned between and an equal distance from the first axial end region 16 and the second axial end region 18. Further, it is to be understood that the schematically illustrated space envelope 14 shown in FIG. 1 is not to scale and the portion of the space envelope 14 between the first axial end region 16 and the second axial end region 18 is larger than illustrated. As such, FIG. 1 is to be understood as a schematic illustration of the dog-bone shaped space envelope 14 in which the components of the axle 10 are disposed. In one application, the first axial end region 16 has an axial length L1 in the range of 220 millimeters to 260 millimeters, and a diameter in the range of 180 millimeters to 220 millimeters. The second axial end region 18 has an axial length L2 in the range of 140 millimeters to 180 millimeters, and a diameter in the range of 180 millimeters to 220 millimeters. The overall axial length of the axle 10 depends on the specific application and the specific vehicle.

As shown in FIG. 1, the axle 10 includes an electric motor 40, an input shaft 42, a compound planetary gearset 50, and a spur gear differential 70, each of which are positioned within the space envelope 14 of the axle 10. The electric motor 40 can be an electric motor that converts electrical energy into mechanical energy, such as for example rotational energy that is provided to an output shaft of the electric motor 40. The electric motor 40 is positioned within the first axial end region 16 of the axle 10. In some examples, as illustrated, the electric motor 40 can be positioned entirely within the first axial end region 16 of the space envelope 14 of the axle 10. Further, in some examples, the electric motor 40 can surround and be positioned concentric with the axis of rotation AR of the axle 10.

The input shaft 42 extends between and couples the electric motor 40 to the compound planetary gearset 50, which is positioned within the second axial end region 18 of the space envelope 14 of the axle 10. More specifically, the input shaft 42 is coupled at a first end to the output shaft of the electric motor 40 for receiving rotational energy from the output shaft of the electric motor 40. The input shaft 42 is coupled at a second end to the compound planetary gearset 50 for transferring the rotational energy from the electric motor 40 to the compound planetary gearset 50, discussed further below. As such, the input shaft 42 extends from the first axial end region 16 to the second axial end region 18 of the axle 10. In some examples, the input shaft 42 can be a hollow shaft that is axially aligned with the axis of rotation AR of the axle 10.

The compound planetary gearset 50 is positioned within the second axial end region 18 of the axle 10. Further, the compound planetary gearset 50 is positioned axially between the electric motor 40 and the spur gear differential 70. In exemplary embodiments, as illustrated, the compound planetary gearset 50 and the spur gear differential 70 can be positioned entirely within the second axial end region 18 of the space envelope 14 of the axle 10. In one example, the compound planetary gearset 50 and the spur gear differential 70 can be positioned within an axial length that extends from the second distal end 22 of the axle 10 towards the first distal end 20 of the axle 10, and the axial length L2 can be between 140 millimeters and 180 millimeters. In other words, the compound planetary gearset 50 and the spur gear differential 70 can be positioned solely within the second axial end region 18 of the axle 10, and the second axial end region 18 can have an axial length L2 between 140 millimeters and 180 millimeters. In one specific example, the axial length L2 of the second axial end region 18 can be 160 millimeters. Further, in some examples, the compound planetary gearset 50 and the spur gear differential 70 can surround and be axially aligned with the axis of rotation AR of the axle 10.

Referring now to FIG. 2, which is a magnified detail view of the second axial end region 18 of the axle 10. The compound planetary gearset 50 includes a first sun gear 52A, a plurality of first planet gears 54A, a first planet carrier 56A, a first ring gear 58A, and a first planet carrier shaft 60. Further, positioned axially closer to the second distal end 22 of the axle, the compound planetary gearset 50 includes a second sun gear 52B, a plurality of second planet gears 54B, a second planet carrier 56B, a second ring gear 58B, and a load stage carrier 62. Each of the components of the compound planetary gearset 50 will be discussed further below.

The first sun gear 52A is axially aligned with the input shaft 42 and the first sun gear 52A is coupled to the input shaft 42 for receiving rotational energy from the electric motor 40. The plurality of first planet gears 54A are positioned radially outwards from the first sun gear 52A, with respect to the axis of rotation AR of the axle 10. Further, each of the plurality of first planet gears 54A are positioned on the first planet carrier 56A. Each of the plurality of first planet gears 54A are configured to mesh with the first sun gear 52A for receiving rotational energy from the first sun gear 52A.

The first ring gear 58A is positioned radially outwards of the plurality of first planet gears 54A, with respect to the axis of rotation AR of the axle 10. The first ring gear 58A is a stationary first ring gear 58A, such that the first ring gear 58A does not rotate during use of the compound planetary gearset 50 and the axle 10. Each of the plurality of first planet gears 54A are configured to mesh and rotate within the stationary first ring gear 58A. The first planet carrier shaft 60 extends from and is rotationally coupled to the first planet carrier 56A for receiving rotational energy from the first planet carrier 56A. Further, the first planet carrier shaft 60 extends from an end of the first planet carrier 56A towards the second distal end 22 of the axle 10.

The first planet carrier shaft 60 is coupled to the second sun gear 52B, which is positioned axially closer to the second distal end 22 of axle 10 than the first planet carrier shaft 60 and the first sun gear 52A. Further, the first planet carrier 56A and the first planet carrier shaft 60 rotationally couple the plurality of first planet gears 54A to the second sun gear 52B, providing rotational energy from the electric motor 40 to the second sun gear 52B. The plurality of second planet gears 54B are positioned radially outwards from the second sun gear 52B, with respect to the axis of rotation AR of the axle 10. Further, each of the plurality of second planet gears 54B are positioned on the second planet carrier 56B. Each of the plurality of second planet gears 54B are configured to mesh with the second sun gear 52B for receiving rotational energy from the second sun gear 52B.

The second ring gear 58B is positioned radially outwards of the plurality of second planet gears 54B, with respect to the axis of rotation AR of the axle 10. Further, the second ring gear 58B is positioned axially closer to the second distal end 22 and radially outwards of the first ring gear 58A. The second ring gear 58B is a stationary second ring gear 58B, such that the second ring gear 58B does not rotate during use of the compound planetary gearset 50 and the axle 10. Each of the plurality of second planet gears 54B are configured to mesh and rotate within the stationary second ring gear 58B. As illustrated and described, the first sun gear 52A, the plurality of first planet gears 54A, and the first ring gear 58A are positioned axially between the electric motor 40 and the second sun gear 52B, the plurality of second planet gears 54B, and the second ring gear 58B.

As shown best in FIG. 2, the second planet carrier 56B rotationally couples the plurality of second planet gears 54B to an input of the spur gear differential 70. More specifically, the load stage carrier 62 extends from and is rotationally coupled to the second planet carrier 56B for receiving rotational energy from the second planet carrier 56B. Further, the load stage carrier 62 extends from an end of the second planet carrier 56B towards the second distal end 22 of the axle 10. The load stage carrier 62 rotationally couples the compound planetary gearset 50 to the spur gear differential 70, for providing rotationally energy from the electric motor 40 to the spur gear differential 70.

The spur gear differential 70 is positioned within the second axial end region 18 of the axle 10. The load stage carrier 62 of the compound planetary gearset 50 extends between and couples the spur gear differential 70 to the compound planetary gearset 50, providing rotational energy from the compound planetary gearset 50 to the spur gear differential 70. The spur gear differential 70 includes a first output 72, a second output 74, a first output shaft 76, and a second output shaft 78. In some examples, the first output 72 can be a splined output or a splined opening that is positioned closer to the first distal end 20 of the axle 10 than the second output 74. In some examples, the second output 74 can be a splined output or a splined opening that is positioned closer to the second distal end 22 of the axle 10 than the first output 72.

The spur gear differential 70 is configured to transfer the rotational energy received from compound planetary gearset 50 to the first output 72 and the second output 74 of the spur gear differential 70. Then the first output 72 and the second output 74 are configured to transfer the rotational energy to the first output shaft 76 and the second output shaft 78, respectively, of the spur gear differential 70. The first output shaft 76 and the second output shaft 78 extend in opposite axial directions along the axis of rotation AR of the axle 10. More specifically, the first output shaft 76 extends from the first output 72 of the spur gear differential 70 to the first wheel hub 30 to transfer rotationally energy from the spur gear differential 70 to the first wheel hub 30. The second output shaft 78 extends from the second output 74 of the spur gear differential 70 to the second wheel hub 32 to transfer rotationally energy from the spur gear differential 70 to the second wheel hub 32.

As shown best in FIG. 1, the first output shaft 76 extends from the second axial end region 18 to the first axial end region 16 of the axle 10, and the second output shaft 78 is positioned and extends fully within the second axial end region 18 of the axle 10. Further, the first output shaft 76 is connected to the first wheel hub 30 positioned at the first distal end 20 of the axle 10, and the second output shaft 78 is connected to the second wheel hub 32 positioned at the second distal end 22 of the axle 10. Therefore, the first output 72 and the first output shaft 76 work in conjunction to transfer rotational energy from the spur gear differential 70 to the first wheel hub 30 positioned distal from the spur gear differential 70. The second output 74 and the second output shaft 78 work in conjunction to transfer rotational energy from the spur gear differential 70 to the second wheel hub 32 positioned adjacent the spur gear differential 70.

As discussed, the input shaft 42 can be a hollow shaft that extends from the first axial end region 16 to the second axial end region 18. In some examples, as illustrated, the first output shaft 76 can be positioned at least partially within and concentric to the input shaft 42. More specifically, a first portion of the first output shaft 76 can be positioned within the hollow input shaft 42, and a second portion of the first output shaft 76 can be positioned outside of the hollow input shaft 42, with both the first and second portions of the first output shaft 76 being axially aligned with the input shaft 42. Therefore, based on the orientation described, it is to be understood that each of the input shaft 42, the first output shaft 76, and the second output shaft 78 can be axially aligned with the axis of rotation AR of the axle 10. Further, based on the orientation described, the electric motor 40, the compound planetary gearset 50, and the spur gear differential 70 can each be positioned concentric with and surround the axis of rotation AR of the first output shaft 76 and the second output shaft 78 of the axle 10.

In operation, the electric motor 40 produces rotational energy in the first axial end region 16 of the axle 10 that is transferred through the input shaft 42 to the compound planetary gearset 50 in the second axial end region 18 of the axle 10. The compound planetary gearset 50 then transfers the rotational energy to the spur gear differential 70, which is also positioned in the second axial end region 18 of the axle 10. The spur gear differential 70 then transfers rotational energy through the first output 72 and the second output 74 to the first output shaft 76 and the second output shaft 78, respectively. The rotational energy received by the first output shaft 76 within the second axial end region 18 is then transferred to the first wheel hub 30 positioned at a first distal end 20, which is adjacent the first axial end region 16 of the axle 10. Further, the rotational energy received by the second output shaft 78 within the second axial end region 18 is then transferred to the second wheel hub 32 positioned at a second distal end 22, which is adjacent the second axial end region 18 of the axle 10.

Therefore, the electric beam axle 10 provides a beam axle for a hybrid and/or electric vehicle in which the input shaft 42, the first output shaft 76, and components of the electric motor 40 are the only rotating components within the first axial end region 16 of the electric beam axle 10. Such a configuration eliminates the need for other gearing and/or rotating components (such as a layshaft and additional gearing) within the first axial end region 16 of the space envelope 14 of the axle 10. In turn, this results in an electric beam axle design that is compact and fits within the desired space envelope 14 or other design space requirements not specifically defined. For example, the space envelope 14 or design space requirements can be based on the positioning of other components/assemblies disposed adjacent the electric beam axle 10 within the hybrid and/or electric vehicle.

Further, the electric beam axle 10 including the compound planetary gearset 50 and the spur gear differential 70 (and the removal of additional gearing within the first axial end region 16 of the axle 10) results in a simpler gearing design that still includes the desired gear ratio. In one specific example, the compound planetary gearset 50 and the spur gear differential 70 can have a combined gear ratio of i=18. In other examples, the compound planetary gearset 50 and the spur gear differential 70 can have a combined gear ratio of greater or less than i=18, depending on the specific application. Therefore, removal of the additional gearing within the first axial end region 16 of the axle 10 results in a less complex axle design that is lower in cost to manufacture and assemble (compared to previous designs), and the axle 10 fits within a desired space envelope 14 within the hybrid and/or electric vehicle.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 Electric Beam Axle
12 Gearbox
14 Space Envelope
16 First Axial End Region
18 Second Axial End Region
20 First Distal End
22 Second Distal End
30 First Wheel Hub
32 Second Wheel Hub
40 Electric Motor
42 Input Shaft
50 Compound Planetary Gearset
52A First Sun Gear
54A First Planet Gears
56A First Planet carrier
58A First Ring Gear
52B Second Sun Gear
54B Second Planet Gear
56B Second Planet Carrier
58B Second Ring Gear
60 First Planet Carrier Shaft
62 Load Stage Carrier
70 Spur Gear Differential
72 First Output
74 Second Output
76 First Output Shaft
78 Second Output Shaft
AR Axis of Rotation

What is claimed is:

1. An electric beam axle for a hybrid or electric vehicle, the electric beam axle comprising:
an electric motor positioned at a first axial end region of the electric beam axle;
a compound planetary gearset positioned at a second axial end region of the electric beam axle;
an input shaft that extends between and couples the compound planetary gearset to the electric motor;
the compound planetary gearset comprising a load stage carrier;
a spur gear differential positioned at the second axial end region, the load stage carrier extends between and couples the spur gear differential to the compound planetary gearset, the spur gear differential comprising a first output shaft and a second output shaft that extend in opposite axial directions;
the first output shaft of the spur gear differential is connected to a first wheel hub positioned at a first distal end of the electric beam axle; and
the second output shaft of the spur gear differential is connected to a second wheel hub positioned at a second distal end of the electric beam axle.

2. The electric beam axle of claim 1, wherein the input shaft is a hollow shaft, and wherein the first output shaft is positioned at least partially within and concentric to the input shaft.

3. The electric beam axle of claim 1, wherein the first output shaft extends from the spur gear differential at the second axial end region to the first axial end region of the electric beam axle, coupling the spur gear differential to the first wheel hub.

4. The electric beam axle of claim 1, wherein the compound planetary gearset is positioned axially between the electric motor and the spur gear differential.

5. The electric beam axle of claim 1, wherein the electric motor, the compound planetary gearset, and the spur gear differential are each concentric with and surround an axis of rotation of the first and second output shafts of the electric beam axle.

6. The electric beam axle of claim 1, wherein the compound planetary gearset comprises:
a first sun gear coupled to the input shaft for receiving rotational energy from the electric motor;
a plurality of first planet gears positioned radially outwards from the first sun gear with respect to the axis of rotation of the electric beam axle on a first planet carrier, each of the plurality of first planet gears are configured to mesh with the first sun gear; and
a stationary first ring gear positioned radially outwards of the plurality of first planet gears, wherein each of the plurality of first planet gears are configured to mesh with the stationary first ring gear.

7. The electric beam axle of claim 6, wherein the compound planetary gearset further comprises:
a first planet carrier shaft extending from the first planet carrier towards the second distal end;
a second sun gear, the first planet carrier shaft rotationally couples the plurality of first planet gears to the second sun gear; and
a plurality of second planet gears positioned radially outwards from the second sun gear with respect to the axis of rotation of the electric beam axle on a second planet carrier, each of the plurality of second planet gears are configured to mesh with the second sun gear.

8. The electric beam axle of claim 7, wherein the second sun gear is positioned axially closer to the second distal end than the first sun gear.

9. The electric beam axle of claim 7, wherein a stationary second ring gear is positioned radially outwards of the plurality of second planet gears, and each of the plurality of second planet gears are configured to mesh with the stationary second ring gear.

10. The electric beam axle of claim 7, wherein the second planet carrier rotationally couples the plurality of second planet gears to an input of the spur gear differential.

11. The electric beam axle of claim 9, wherein the first sun gear, the plurality of first planet gears, and the first ring gear are positioned axially between the electric motor and the second sun gear, the plurality of second planet gears, and the second ring gear.

12. The electric beam axle of claim 1, wherein each of the input shaft, the first output shaft, and the second output shaft are axially aligned with the axis of rotation of the of the electric beam axle.

13. The electric beam axle of claim 1, wherein:
each of the electric motor, the compound planetary gearset, and the spur gear differential are positioned within a space envelope defined between the first distal end and the second distal end of the electric beam axle; and
the space envelope includes a dog bone shape, such that the first and second axial end regions of the electric beam axle include an outer diameter larger than an outer diameter of the electric beam axle at a location positioned an equal distance from the first axial end region and the second axial end region.

14. The electric beam axle of claim 1, wherein the electric beam axle is configured to be a front axle of the hybrid or electric vehicle.

15. An electric beam axle for a hybrid or electric vehicle, the electric beam axle comprising:
an electric motor positioned at a first axial end region of the electric beam axle;
a compound planetary gearset positioned at a second axial end region of the electric beam axle;
an input shaft that extends between and couples the compound planetary gearset to the electric motor; and
a spur gear differential positioned at the second axial end region and coupled to the compound planetary gearset, the spur gear differential being connected through at least one shaft to a first wheel hub positioned at a first distal end of the electric beam axle and to a second wheel hub positioned at a second distal end of the electric beam axle;
wherein the compound planetary gearset and the spur gear differential are positioned solely within the second axial end region of the electric beam axle.

16. The electric beam axle of claim 15, wherein the compound planetary gearset and the spur gear differential are positioned within an axial length extending from the second distal end towards the first distal end of the electric beam axle, the axial length being between 140 millimeters and 180 millimeters.

17. The electric beam axle of claim 15, wherein the compound planetary gearset and the spur gear differential have a combined gear ratio of i=18.

18. The electric beam axle of claim 15, wherein the at least one shaft comprises a first output shaft extending between and connecting the spur gear differential to the first wheel hub, and a second output shaft extending between and connecting the spur gear differential to the second wheel hub.

19. The electric beam axle of claim 18, wherein the input shaft, the first output shaft, and components of the electric motor are the only rotating components within the first axial end region of the electric beam axle.

20. An electric beam axle for a hybrid or electric vehicle, the electric beam axle comprising:
an electric motor positioned at a first axial end region of the electric beam axle;
a compound planetary gearset positioned at a second axial end region of the electric beam axle;
a hollow input shaft that extends between and couples the compound planetary gearset to the electric motor;
a spur gear differential positioned at the second axial end region and coupled to the compound planetary gearset, the spur gear differential comprising a first output shaft and a second output shaft;
wherein the first output shaft of the spur gear differential extends through the hollow input shaft and is connected to a first wheel hub, and the second output shaft of the spur gear differential extends in an opposite axial direction as the first output shaft and is connected to a second wheel hub.
